(19) United States
(12) Patent Application Publication
(10) Pub. No.: US 2026/0366578 A1
(43) Pub. Date: Nov. 19, 2026

(54) GROOVE PATTERN FOR FRICTION PLATES

(71) Applicant: Schaeffler Technologies AG & Co. KG, Herzogenaurach (DE)

(72) Inventors: Benjamin Baerwald, Kuppenheim (DE); Christian Denda, Archern (DE); Alexander Brielmaier, Rheinmunster (DE)

(73) Assignee: Schaeffler Technologies AG & Co. KG, Herzogenaurach (DE)

(21) Appl. No.: 19/135,279

(22) PCT Filed: Nov. 3, 2023
(86) PCT No.: PCT/DE2023/100814

§ 371 Date: Jun. 3, 2025

(30) Foreign Application Priority Data
Dec. 5, 2022 (DE) 10 2022 132 147.9
Jan. 27, 2023 (DE) 10 2023 102 033.1

(51) Int. Cl. F16D 13/72; F16D 13/64

(52) U.S. Cl. CPC F16D 13/72; F16D 13/648; F16D 2300/10

(57) ABSTRACT

The disclosure relates to a groove pattern for friction plates, the groove pattern being formed by friction lining pads and each friction lining pad having a friction surface and the friction lining pads being separated from each other by segmentation grooves, and each friction lining pad additionally has embossed grooves on its friction surface.

### CROSS-REFERENCE TO RELATED APPLICATIONS

This application is the U.S. National Phase of PCT Appln. No. PCT/DE2023/100814, filed Nov. 3, 2023, which claims the benefit of German Patent Appln. Nos. 102022132147.9, filed Dec. 5, 2022, and 102023102033.1, filed Jan. 27, 2023, the entire disclosures of which are incorporated by reference herein.

### TECHNICAL FIELD

The present disclosure relates to a groove pattern for friction plates.

Grooves or groove patterns—also referred to as groove geometry, groove design, or pad geometry or pad design in the context of this document—are used to cool the plates through an oil flow, even when the shifting elements are closed. They cut through the oil film and thereby stabilize the friction coefficient. This creates the desired friction behavior when shifting. The idling behavior is improved and the drag torque is reduced.

### BACKGROUND

Wet-running multiple disc clutches and brakes are widely used in conventional power-shiftable transmissions, in novel hybrid modules in heavy-duty drive trains or in shiftable e-axles, and they represent high-performance, heavy-duty components. The demands for lower CO2 emissions and improved efficiency of drive trains in automotive applications are of great importance. In addition to reducing load-independent losses in shifting elements, the thermal load and adequate cooling must be taken into account. The groove pattern of the friction disc plays a central role in the trade-off between friction characteristics, thermal balance, and efficiency.

DE 10 2021 107 843 A1 discloses groove patterns for friction plates, wherein the groove pattern is formed by means of friction lining pads and the friction lining pads have a trapezoidal shape and wherein each friction lining pad has waffle-shaped grooves.

WO 2016 180 540 A1 discloses annular wet-running friction linings having a first set of grooves consisting of straight-running grooves that connect the inner circumference with the outer circumference and do not intersect.

US 2009 0 211 867 A1 discloses annular wet-running friction linings having a first set of grooves which connect the inner circumference and the outer circumference and form trapezoidal friction pads which form the annular friction lining, and a second set of embossed grooves.

U.S. Pat. No. 3,972,400 A1 discloses annular wet-running friction linings having a first set of grooves consisting of radial and straight-running grooves and a second set of non-radial and straight-running grooves connecting the inner circumference and the outer circumference.

### SUMMARY

The disclosure is based on the object of improving the cooling of friction plates by means of a suitable groove pattern and optimizing the surface pressure in the frictional contact.

The object is achieved by a groove pattern having the features set forth herein.

The groove pattern for friction plates according to the disclosure therefore provides that the groove pattern is formed by means of friction lining pads and each friction lining pad has a friction surface and the friction lining pads are separated from one another by segmentation grooves. It is intended that each friction pad has additional embossed grooves on the friction surface.

The groove pattern for friction plates according to the disclosure is thus formed by means of friction lining pads and the friction lining pads are attached to a carrier plate and separated from one another by segmentation grooves. The segmentation grooves are therefore limited in their depth by the carrier plate and, in particular, do not contain any friction pad material or any other friction lining material in their depth. The carrier plate together with the friction pads is referred to as the friction plate. In addition to the segmentation grooves, the friction surface of the friction lining, i.e., the friction surface of the friction lining pads themselves also has grooves, wherein the groove depth of these grooves does not reach to the bottom of the pads and therefore certainly not to the metallic carrier element, namely the carrier plate of the pads. In this document, these grooves on the friction side of the pads or in the pads are referred to as embossed grooves. The term “embossed grooves” is not to be understood as meaning that the embossed grooves are only formed by embossing or over-embossing, but within the scope of this document, the term “embossed groove” is intended to also include other manufacturing processes for the embossed grooves, such as milling and/or grinding, etc.

In a preferred embodiment of the disclosure, it is provided that the embossed grooves on the friction surface of the friction lining pads are formed either by over-embossing or by milling and/or grinding and/or the segmentation grooves running radially between the friction lining pads.

In a further preferred embodiment of the disclosure, it is provided that the areas which are only—i.e., exclusively—enclosed by embossed grooves, in the sense of being surrounded or bordered thereby, have a kite quadrilateral shape and that the areas and/or the edge lengths of the kite quadrilateral which are only—i.e., exclusively—enclosed by embossed grooves become larger from the radial inside to the radial outside.

In a further preferred embodiment of the disclosure, it is provided that the course of the embossed grooves across all friction lining pads has a common kite quadrilateral structure, and is only interrupted by the segmentation grooves.

In a preferred embodiment of the disclosure, it is provided that each embossed groove is inclined in one of the two circumferential directions with respect to a radial course and this results in its belonging to one of two groove groups.

The first groove group thus comprises the embossed grooves which are inclined in a predetermined first circumferential direction and the second groove group thus comprises the embossed grooves which are inclined in the other of the two circumferential directions.

In the following, the inclination is not given relative to the radial, but relative to the tangent to the inner circumference that is orthogonal to the radial, wherein the interface between the course of the center line of the embossed groove and the course of the inner circumference is taken as the starting point of the radial as well as the starting point of the tangent to the inner circumference.

In a further preferred embodiment of the disclosure, it is provided that the inclination of the embossed grooves is determined by means of the angle γ between the center line of the embossed groove and the inner circumference tangent at an interface between the course of the center line of the embossed groove and the course of the inner circumference.

The angle γ is always given as a mathematical absolute value. There is therefore no sign assignment or a meaning assignment with regards to a sign of the angle γ. Of the four angles resulting at each intersection of two straight lines, two of which are identical, the smaller of the two values is chosen for the angle γ. The two straight lines here are the center line of the embossed groove and the inner circumference tangent. From the angle γ alone it is then no longer possible to determine to which groove group the corresponding embossed groove belongs.

In a further preferred embodiment of the disclosure, it is provided that all intersection points of the center lines lie on two embossed grooves (X-intersections) with an intersection angle of 90 degrees (90-degree X-intersections) on a circle (circle of 90-degree X-intersections) with a radius Rₓ, which is between inner radius (Rᵢ) and outer radius (Rₐ) of the friction lining, wherein:

$${R}_{x} = \sqrt{{R}_{k}^{2} + {R}_{k}^{2}} with {R}_{k} = {R}_{l} sin α with α = 90 ° - γ$$

In a further preferred embodiment of the disclosure, it is provided that all intersection points of the center lines of two embossed grooves (X-intersections) that are not on the circle with a radius Rₓ (circle of 90-degree X intersections) have an intersection angle other than 90 degrees.

In a further preferred embodiment of the disclosure, it is provided that two embossed grooves have the same value for the respective angle γ if the two center lines the embossed grooves have their intersection on the circle with radius Rₓ.

In this case, γ(NG1)=γ′(NG2), so both have the same angle of inclination γ with respect to their respective circumferential tangent (cf. FIG. 12).

In a further preferred embodiment of the disclosure, it is provided that all center lines of all embossed grooves of the groove group 1 form tangents to a common circle with a common radius Rₖ₁.

In a further preferred embodiment of the disclosure, it is provided that all center lines of all embossed grooves of the groove group 2 form tangents to a common circle with a common radius Rₖ₂.

In a further preferred embodiment of the disclosure, it is provided that all center lines of all embossed grooves form tangents to a common circle with a common radius Rₖ. Therefore, Rₖ₁=Rₖ₂=Rₖ. The center lines of the embossed grooves of groove group 1 as well as the center lines of the embossed grooves of groove group 2 form tangents to a common circle with a common radius Rₖ.

This radius Rₖ is referred to in this document as tangential radius Rₖ and the corresponding diameter is designated with “a” (see FIGS. 9, 10)

In a further preferred embodiment of the disclosure, it is provided that the angle γ is chosen to be between 0 and 45°, preferably from the range between 40° and 44°.

In this way, both cooling and surface pressure are advantageously improved.

Further advantages and advantageous configurations of the disclosure are the subject of the following figures and the description thereof.

### BRIEF DESCRIPTION OF THE DRAWINGS

In the figures, in detail:

FIG. 1 shows a lubrication concept of wet multiple disc clutches/brakes with internal lubrication;

FIG. 2 shows a schematic diagram of a wet multiple disc clutch with internal lubrication;

FIG. 3 shows a schematic representation of the groove design of a friction lining according to the disclosure;

FIG. 4 shows a schematic representation of the groove design of a friction lining according to the disclosure;

FIG. 5 shows a dimensioning of the groove design according to the disclosure;

FIG. 6 shows a dimensioning of the groove design according to the disclosure;

FIG. 7 shows a dimensioning of the groove design according to the disclosure;

FIG. 8 shows an oil flow in the groove design according to the disclosure;

FIG. 9 shows an embodiment of the groove design according to the disclosure on a narrower friction plate with center lines of the embossed grooves;

FIG. 10 shows an embodiment of the groove design according to the disclosure on a wider friction plate with center lines of the embossed grooves;

FIG. 11 shows a procedure for designing the inventive groove design of the embossed grooves;

FIG. 12 shows a procedure for designing the groove design of the embossed grooves according to the disclosure;

FIG. 13 shows a dimensioning of the embodiment of the groove design according to the disclosure on the narrower friction plate;

FIG. 14 shows a dimensioning of the embodiment of the groove design according to the disclosure on the wider friction plate;

FIG. 15 shows an alternative groove design according to the disclosure, with group parallel grooving of the segmentation grooves;

FIG. 16 shows a dimensioning of the groove cross-section of the embossed groove design according to the disclosure;

FIG. 17 shows a comparison of the groove design according to the disclosure with a conventional waffle grooving; and

FIG. 18 shows a simplified heat balance for convective cooling of a friction contact.

### DETAILED DESCRIPTION

Relevant parameters for convective heat transfer:
Volume flow (P_{oil,out})
Thermal mass of the oil in the grooving, oil volume in the groove of the friction disc (Vₒᵢₗ)
Heat transfer coefficient (α)
Heat transfer surface (A)

By means of the groove design according to the disclosure, optimization of the following points is intended:

### Friction Characteristics (in the Closing State):

Improvement of the friction coefficient increase by reducing the lubricating wedge effect and the resulting hydrodynamic pressure at the leading edges of the embossed grooves (relief of the solid body contact surfaces) through an embossed groove angle γ which is particularly preferably selected between 40° and 44°. The angled embossed grooves reduce the radial component of the groove and the resulting force component of the hydrodynamic pressure, thus reducing the structure of the contact pressure in frictional contact improved (avoiding hydroplaning).

### Cooling (in the Closed State):

Using a simplified heat balance for the convective cooling of a friction contact (cf. FIG. 18) it can be deduced that in addition to the necessary cooling oil volume flow, a sufficient groove volume or oil volume must also be present at the friction contact. The heat transfer into the thermal mass of the oil is determined by the temperature difference, the heat transfer coefficient and the heat transfer area. The degree to which the grooves are filled with oil plays an important role. Additional air in the grooves can reduce the cooling performance.

When designing the groove pattern, in addition to the segmentation of the friction lining, the additional grooving of the lining segments (friction lining pads) plays an important role in the convective heat transfer between the cooling oil and the counter friction disc.

If the additional grooving of the lining segments is designed as crossing grooving, the cooling oil is guided in a rotationally symmetrical manner to the surface of the counter friction disc. This leads to an improved distribution of the cooling oil over the circumference of the friction surface and an optimized contact surface for convective heat transfer between the cooling oil and the steel plate.

Furthermore, the total cross-sectional area of the grooves remains constant in the radial direction from the inner friction diameter to the outer friction diameter. As a result, the degree of groove filling of the grooves on the covering segments remains stable and the air intake in the grooves is reduced. This improves the convective heat transfer from the counter friction disc to the cooling oil, and increases the cooling performance.

### Surface Pressure:

Through the optimized cooling of the intersecting embossed grooves (X-grooves), the groove portion can be reduced or the portion of the net friction surface increased. The nominal surface pressure in the frictional contact is thus reduced, which can also have a beneficial effect on the friction characteristics.

General functional description of groove patterns:
Cooling of the plates by oil flow even when the switching element is closed
Cutting through the oil film and thereby stabilizing the friction coefficient.
Creating the desired friction behavior when switching
Improving the idling behavior, reduction of drag torque

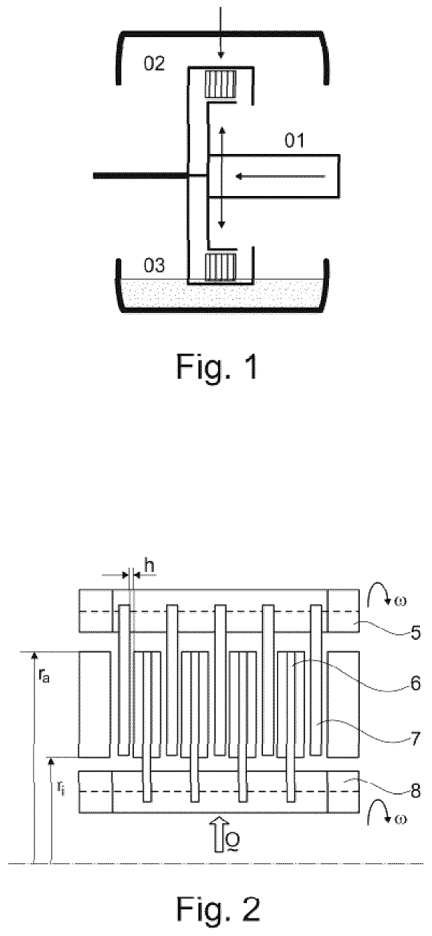

In FIG. 1, the lubrication concept of wet multiple disc clutches/brakes with internal lubrication is shown:
The lubrication concept can be implemented differently for wet-running multiple disc clutches and disc brakes depending on the application.
In general, the cooling oil of the friction systems is supplied from inside 01 either actively (e.g., double clutches, pressure lubrication) or passively (shifting elements in stepped automatic transmissions, passive oil distribution in the transmission).
Depending on the design of the transmission, the friction system can additionally be operated in an oil bath 03.
In the special case of disc brakes (stepped automatic transmissions, hybrid transmissions, or e-axles), active external lubrication 02 can be useful.

FIG. 2 shows the applications of wet multiple disc clutches with internal lubrication:
Automatic transmissions (DCT, AT)
DHT (Dedicated Hybrid Transmission)
Multi-stage e-axles

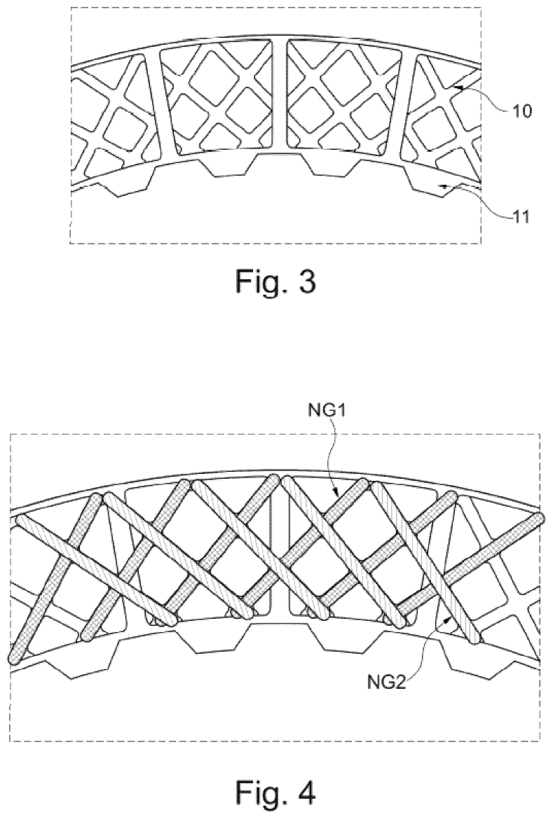

It is shown in FIGS. 3 to 8:

FIGS. 3 and 4 show a schematic representation of the groove pattern according to the disclosure for friction plates, wherein the groove pattern is formed by means of friction lining pads and the friction lining pads 10 are fastened to a carrier plate 11 and are separated from one another by segmentation grooves. The depth of the segmentation grooves is therefore limited by the carrier plate. The carrier plate together with the friction pads is referred to as the friction plate. In addition to the segmentation grooves, the friction lining pads also have embossed grooves 15, 16, whereby the groove depth of the embossed grooves does not reach to the bottom of the pads and thus certainly not to the carrier element, namely the carrier plate 11 of the pads. In this document, the term “embossed grooves” is not to be understood to mean that the embossed grooves are only formed by embossing or over-embossing, but the term “embossed groove” should, within the scope of this document, also include other manufacturing processes for the embossed grooves, such as milling and/or grinding, etc.

The specified number of embossed grooves 15 form a groove set, hereinafter referred to as the groove group 1 NG1 and the specified number of embossed grooves 16 form another groove set, hereinafter referred to as the groove group 2 NG2. The number of embossed grooves in both groove groups is the same, i.e., the specified number of embossed grooves 15 and the specified number of embossed grooves 16 are the same.

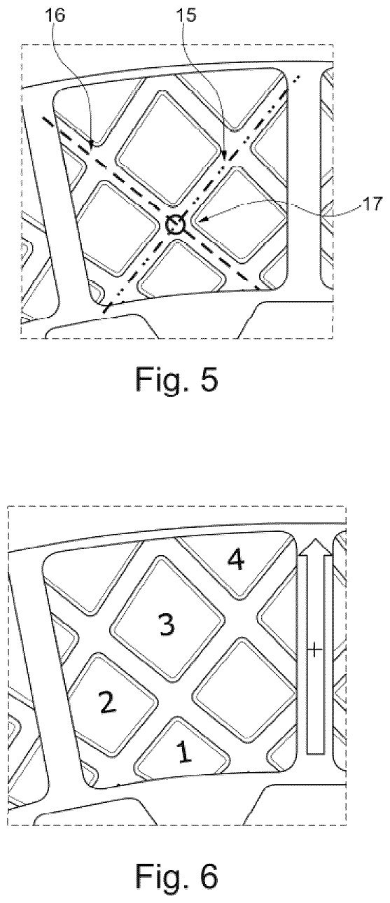

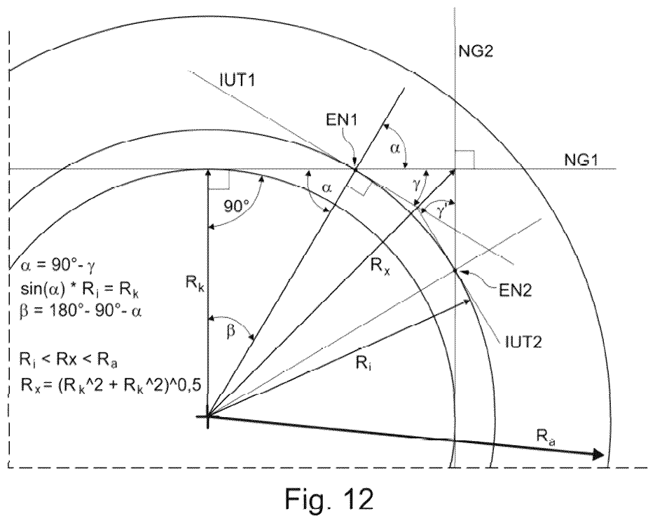

The embossed grooves 15 are inclined relative to a radial (as shown for example in FIG. 12 between the origin and EN1, and between the origin and EN2) with a radial course inclined in the circumferential direction (FIG. 12: NG1). The embossed grooves 16 are inclined in the other circumferential directions relative to the radial (FIG. 12: NG2). In the schematic representation, the segmentation grooves that separate the friction pads from each other also show such a radial course, and connect the inner contact with the outer circumference of the friction lining. However, the disclosure is not limited to a strictly radial course of the segmentation grooves. The embossed grooves 15 and 16 also connect the inner circumference with the outer circumference, but can lead into the segmentation grooves. None of the embossed grooves 15 from the groove group NG1 cross each other, since they all have the same inclination. The inclination is given (see FIG. 12) by means of the angle γ between the embossed groove NG1 and the inner circumference tangent IUT1 at the interface EN1 between the course of the center line of the embossed groove NG1 and the course of the inner circumference (Rᵢ). Also, for the same reason, all embossed grooves 16 from groove group 2 do not cross each other. However, embossed grooves 15 from groove group 1 can intersect with embossed grooves 16 from groove group 2, as shown, for example, at intersection point 17. In this document, such intersections 17 are referred to as “X-intersections” designated. (FIG. 5)

Areas on the surface of a friction pad that are surrounded on all sides by embossed grooves—regardless of the groove group—i.e., areas that are not also bordered by segmentation grooves or the outer or inner edges of the pads, form the geometric shape of kite quadrilaterals (of the 4 edges of a kite quadrilateral, 2 edges that are immediately adjacent to one another at a corner point are the same length).

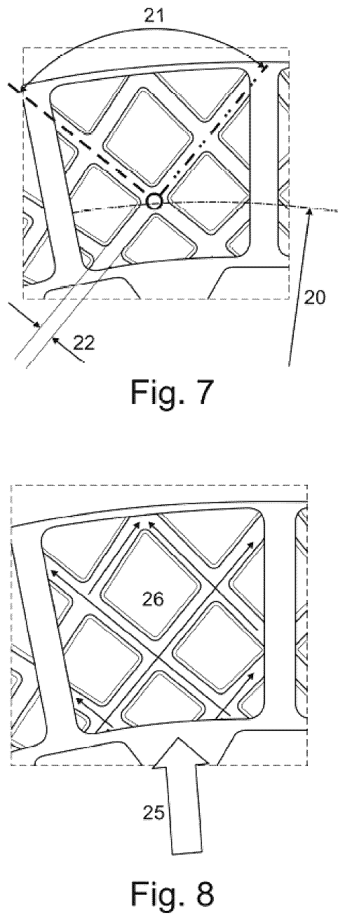

These kite quadrilaterals increase in size from radially inward to outward. The edge lengths of the kite quadrilateral 4 are larger than the corresponding edge lengths of the kite quadrilateral 3, which themselves are larger than the corresponding edge lengths of the kite quadrilateral 2, which themselves are larger than the corresponding edge lengths of the kite quadrilateral 1 (FIG. 6). The same applies to the area of the kite quadrilaterals.
FIG. 7: X-intersections with a 90-degree cutting angle 21 (referred to in this document as “90-degree X-intersections”) of the embossed grooves lie on a circle with radius 20, which is located between inner radius Rᵢ and outer radius Rₐ of the friction lining, so on the friction lining within the friction surface. In the context of this document, the circle with radius 20 is referred to as circle of 90-degree X-intersections.
X-intersections that do not lie on the circle of 90-degree X-intersections have an intersection angle that differs from 90 degrees.
The width 6 of an embossed groove is constant along the groove, and is the same for all embossed grooves: 0.8 to 1.4 mm, preferably 1.2 mm (FIG. 7)
The number of X-crossings per pad of the friction lining is at least 1, depending on pad size and pad shape
The oil flow 25 usually occurs from the inside to the outside (FIG. 8).
The groove portion decreases from the inner circumference to the outer circumference.
Embossed grooves 26 always connect the inner circumference with the outer circumference, or lead into segmentation grooves
The leading edges of the embossed grooves 26 for fluid are never aligned orthogonally (vertically, transversely) to the sliding direction of the friction lining or the friction plate (circumferential direction), i.e., embossed grooves 26 do not run radially.
Teeth and tooth gaps of the internal toothing or of an external toothing, not shown, of the carrier plate can, for example, be coordinated with regard to number, width, and position to the arrangement of the friction pads or the segmentation grooves, but also alternatively or additionally to the number, width, and position of the embossed grooves, in particular their inlet openings on the toothing side, but also to their inclination. A coordination of the positions of the oil supply openings (not shown) can also be taken into account for further optimization.

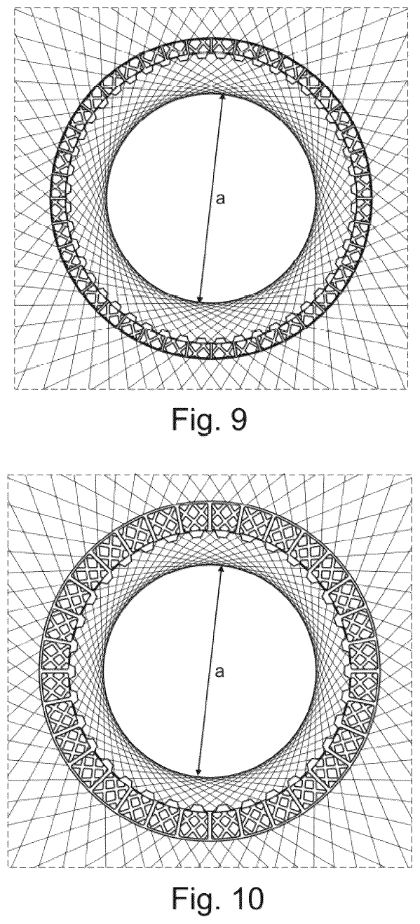

FIGS. 9 and 10, it is shown that a condition for the course of the embossed grooves is that all center lines of the embossed grooves simultaneously represent tangents to a common circle with a common diameter (a) or with a common tangential radius Rₖ.

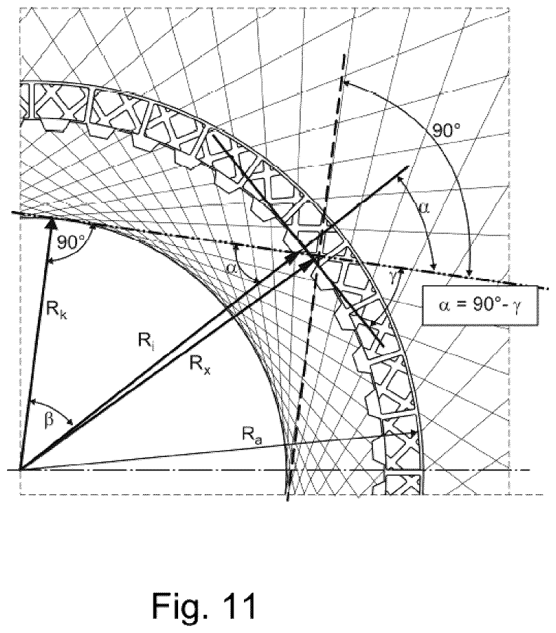

Based on FIGS. 11 and 12, it is shown completely how the groove design of the present disclosure of the embossed grooves is created:

Legend to FIGS. 11 and 12:

| | |
|---|---|
| Rₖ | Tangential radius (circle of tangents) (see FIG. 9, 10 (a)) |
| Rᵢ | Friction radius inside |
| Rₐ | Friction radius outside |
| Rₓ | Radius of the circle of the 90-degree X-intersections (see FIG. 7 |
| | (20)) |
| NG1 | Embossed groove of the first groove group |
| NG2 | Embossed groove of the second groove group |
| EN1 | Inlet opening of the embossed groove of NG1 |
| EN2 | Inlet opening of the embossed groove of NG2 |
| IUT1 | Inner circumference tangent to EN1 |
| IUT2 | Inner circumference tangent to EN2 |

The groove design of the embossed grooves is entirely made up of 2 groove groups:
1. Evenly distributed over 360° along the inner circumference (Rᵢ), inlet openings EN1 of the embossed grooves of the first groove group are established along the inner circumference Rᵢ. For example, 60- or 64-piece embossed groove entry openings EN1 are distributed over the inner circumference at equal distances from each other.
2. The angle γ is established (angle between the embossed groove NG1 of the first groove group and the inner circumference tangent IUT1 at the inlet opening EN1).
3. The radius of the circle of 90-degree X intersections Rₓ (Rᵢ<Rₓ<Rₐ) is calculated according to:

$${R}_{x} = \sqrt{{R}_{k}^{2} + {R}_{k}^{2}}$$

with Rₖ=Rᵢ sin α with α=90°−γ and additionally: 0°<γ<45°, and particularly preferably: 40°<γ<44°
4. At each intersection of the circle of 90-degree X-intersections (Rₓ) with the center line of an embossed groove of the first groove group NG1, e.g., running at the tip of the vector \vec{Rₓ}, one each, also through this intersection point \vec{Rₓ}, provides a center line of a second embossed groove NG2 running perpendicular to the center line of the embossed groove of the first group NG1. These second embossed grooves form the second groove group NG2 of the embossed grooves.

If this described procedure is carried out at all intended inlet openings EN1 of the embossed grooves of the first groove group, an embossed groove of the second groove group results for each embossed groove of the first groove group.

For each embossed groove NG1 from the first groove group and an embossed groove NG2 determined in this way for this embossed groove NG1 from the second groove group, it is true that (FIG. 12): γ(NG1)=γ′(NG2)

Additional explanations of the above-mentioned value ranges of γ:
if γ=0°, then Rₖ=Rᵢ
if γ=45°, then Rₓ=Rᵢ

When choosing the angle γ, the following boundary conditions should be taken into account:
from Rₖ<Rᵢ, it follows that γ>0°
from Rₓ>Rᵢ, it follows that γ<45°
   thus, we get: 0°<γ<45°

In addition, the range of values of γ is further restricted by the following boundary condition: (Rᵢ+2 mm)<R_{x<}(Rₐ−2 mm)

This boundary condition arises when production-related reasons with regard to tolerances must be taken into account: Rₓ should always be located within the friction surface (friction ring formed from friction pads) so that areas in the immediate vicinity of the inner circumference or the outer circumference of the friction ring should be excluded as the location of an intersection point of the circle of 90-degree X intersections (Rₓ) with an embossed groove of the first groove group NG1 (see point 4 of the procedure described above).

This results in a further restriction for γ, so that under these boundary conditions the angle γ preferably chosen to lie in the range 40°<γ<44°.

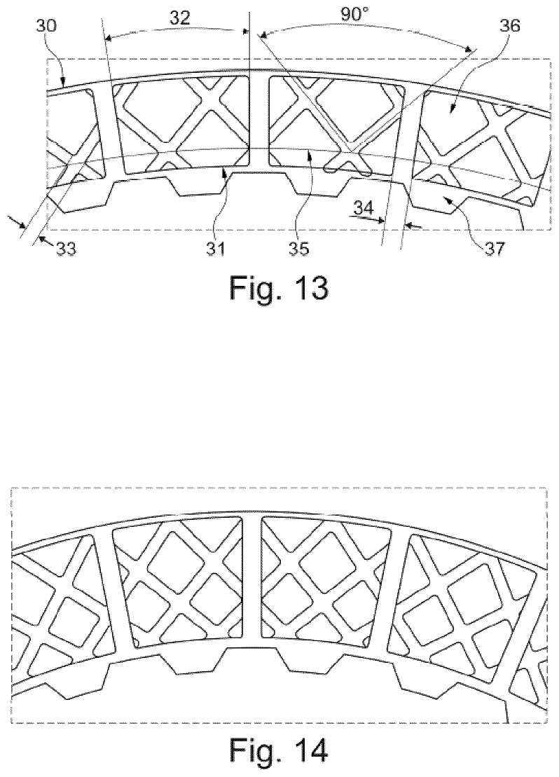

In FIGS. 13 and 14, is shown the dimensioning of two preferred embodiments of groove patterns according to the disclosure for friction plates:

Dimensioning of the embodiment of the groove design according to the disclosure with a narrower friction ring made of friction lining pads on the narrower friction plate according to FIG. 13:

| | | | |
|---|---|---|---|
| (30) | Outside friction diameter (2 * Rₐ) | [mm] | 213.6 |
| (31) | Friction diameter inside (2 * Rᵢ) | [mm] | 194.4 |
| (32) | Segmentation (number and width of pads | | 40 * 9° |
| | including segmentation groove) | | |
| (33) | Width of the embossed grooves | [mm] | 1.2 |
| (34) | Width of the segmentation grooves (groove | [mm] | 2 |
| | between the pads) | | |
| | Diameter circle of tangents (2 * Rₖ) | [mm] | 140.2 |
| (35) | Diameter circle of 90-degree X intersections | [mm] | 198.3 |
| | (2 * Rₓ) | | |
| | Angle γ | [°] | 43.8 |
| | Number of embossed grooves per groove group | [—] | 64 |

Dimensioning of the embodiment of the groove design according to the disclosure with a wider friction ring made of friction lining pads on the wider friction plate according to FIG. 14 (reference symbols analogous to FIG. 13):

| | | | |
|---|---|---|---|
| (30) | Friction diameter, outer (2 * Rₐ) | [mm] | 168.8 |
| (31) | Friction diameter, inner (2 * Rᵢ) | [mm] | 141.8 |
| (32) | Segmentation (number and width of pads | | 32 * 11.25° |
| | including segmentation groove) | | |
| (33) | Width of the embossed grooves | [mm] | 1.2 |
| (34) | Width of the segmentation grooves (groove | [mm] | 2 |
| | between the pads) | | |
| | Diameter circle of tangents (2 * Rₖ) | [mm] | 106.5 |
| (35) | Diameter circle of 90-degree X intersections | [mm] | 150.6 |
| | (2 * Rₓ) | | |
| | Angle γ | [°] | 41.3 |
| | Number of embossed grooves per groove | [—] | 60 |
| | group | | |

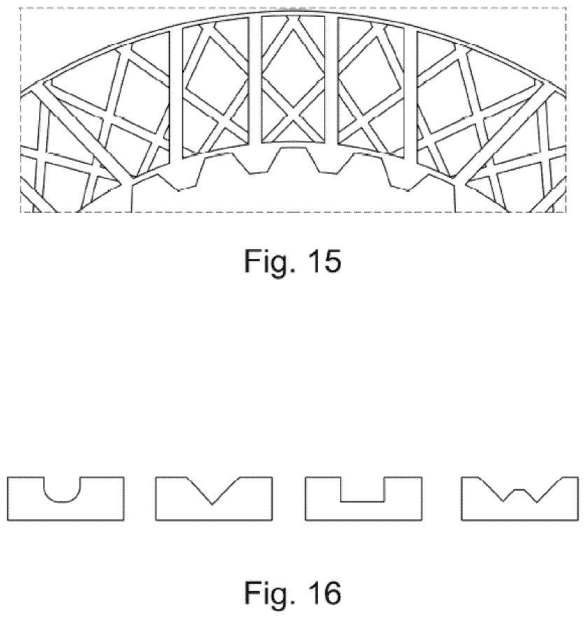

FIG. 15 shows an alternative form of friction pad geometry:

As an alternative to the friction pad geometry shown so far, which results from radially running segmentation grooves, a group-parallel arrangement of the segmentation grooves is shown which also represents an advantageous friction pad geometry.

Instead of the friction pad geometry, which results from radially running segmentation grooves, a possible friction pad geometry can also be formed from the following friction pad shapes, which are separated from each other by corresponding segmentation grooves: trapezoid, square, rectangle, triangle, circle, etc.

FIG. 16 shows alternative forms of the embossed groove cross-sections:

U-shaped, V-shaped, rectangular, W-shaped (with or without rounded edges, e.g., by embossing).

Possible variations regarding the manufacturing process of the embossed grooves:

Instead of embossing the grooves, these grooves are milled and/or ground.

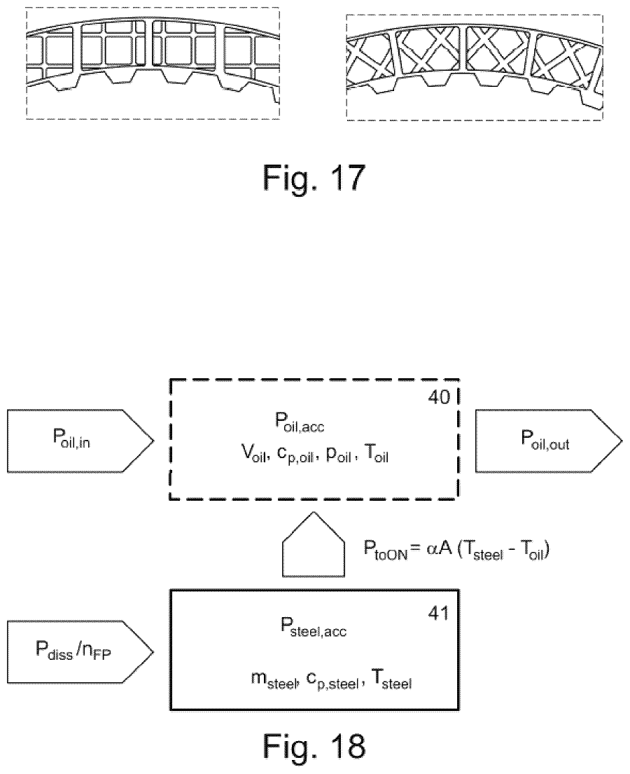

FIG. 17 shows:

In comparison to a conventional waffle grooving (FIG. 17, left), the implementation of the groove design according to the disclosure (FIG. 17, right) can increase the cooling performance by 7.5% under the same boundary conditions, and at the same time can reduce the groove portion and thus the nominal surface pressure in the friction contact by 8%, which has a beneficial effect on the friction characteristics.

### LIST OF REFERENCE SYMBOLS

01 Lubrication from the inside (active, passive)
02 Lubrication from the outside
03 Immersion bath, oil bath
5 Outer plate carrier (outer plate carrier/housing)
6 Friction plate (friction plate)
7 Steel plate (steel plate)
8 Inner plate carrier (inner plate carrier)
10 Friction pad
11 Carrier plate
NG1 Groove group 1
NG2 Groove group 2
15 Embossed groove from NG1
16 Embossed groove from NG2
17 X-intersection, intersection of embossed grooves
1, 2, 3, 4 Kite quadrilaterals limited exclusively by embossed grooves 15, 16
20 Rₓ: radius of the circle of 90-degree X intersections
21 Cutting angle of embossed grooves
22 Width of the embossed groove
25 Oil flow direction
26 Embossed grooves
Rₖ Tangential radius (circle of tangents) (see FIG. 9, 10 (a))
Rᵢₙ Friction radius, inner
Rₐ Friction radius, outer
Rₓ Radius of the circle of the 90-degree X-intersections (see FIG. 7 (20))
NG1 Embossed groove of the first groove group
NG2 Embossed groove of the second groove group
EN1 Inlet opening of the embossed groove of the NG1
EN2 Inlet opening of the embossed groove of the NG2
IUT1 Inner circumference tangent to the EN1
IUT2 Inner circumference tangent to the EN2
30 Friction diameter outer (2*Rₐ)
31 Friction diameter inner (2*Rᵢ)
32 Segmentation (number and width of pads including segmentation groove)
33 Width of the embossed grooves
34 Width of the segmentation grooves (groove between the pads)
35 Diameter circle of 90-degree X intersections (2*Rₓ)
36 Friction pad
37 Carrier plate
40 Oil volume
41 Counter friction disc

1. A friction plate comprising:
a carrier plate; and
a plurality of friction pads attached to the carrier plate;
wherein the friction plate has a groove pattern being formed by the friction pads and each friction having a friction surface and the friction pads being separated from each other by segmentation grooves, wherein each friction pad on the friction surface additionally has embossed grooves.

2. The friction plate according to claim 1, wherein the embossed grooves on the friction surface of the friction lining pads are at least one of over embossed, milled, or grinded grooves, or the segmentation grooves run radially between the friction pads.

3. The friction plate according to claim 1, wherein surfaces of the friction pads which are exclusively surrounded by embossed grooves have a kite quadrilateral shape, and at least one of the surfaces of the friction pads or edge lengths of the kite quadrilaterals which are exclusively surrounded by embossed grooves become larger from radially inside to radially outside.

4. The friction plate according to claim 1, wherein each embossed groove is inclined in one of the two circumferential directions with respect to a radial course, and this results in its belonging to one of two groove groups.

5. The friction plate according to claim 4, wherein the inclination of the embossed grooves is given by means of an angle γ between a center line of the embossed groove and an inner circumference tangent at an interface between the course of the center line of the embossed groove and a course of the inner circumference of the friction pads.

6. The friction plate according to claim 5, wherein all intersection points of the center lines of two embossed grooves which have an intersection angle of 90 degrees lie on a circle with a radius Rₓ, which is between an inner radius (Rᵢ) and an outer radius (Rₐ) of a friction lining, where:
$${R}_{x} = \sqrt{{R}_{k}^{2} + {R}_{k}^{2}} with {R}_{k} = {R}_{l} sin α with α = 90 ° - γ$$

7. The friction plate according to claim 6, wherein all intersection points of the center lines of two embossed grooves which are not on the circle with a radius Rₓ have an intersection angle other than 90 degrees.

8. The friction plate according to claim 6, wherein two embossed grooves have the same value for the respective angle γ if the center lines of the two embossed grooves have their intersection point on the circle with radius Rₓ.

9. The friction plate according to claim 1, wherein all center lines of all embossed grooves form tangents to a common circle with a common radius Rₖ.

10. The friction plate according to claim 5, wherein the angle γ is chosen to be between 0 and 45°, preferably from the range between 40° and 44°.

11. A drive train component including a clutch comprising:
a friction plate comprising:
a carrier plate; and
a plurality of friction pads attached to the carrier plate;
wherein the friction plate has a groove pattern being formed by the friction pads and each friction pad having a friction surface and the friction pads being separated from each other by segmentation grooves, wherein each friction pad on the friction surface additionally has embossed grooves.

12. The drive train component according to claim 11, wherein the embossed grooves on the friction surface of the friction lining pads are at least one of over embossed, milled, or grinded grooves, or the segmentation grooves run radially between the friction pads.

13. The drive train component according to claim 11, wherein surfaces of the friction pads which are exclusively surrounded by embossed grooves have a kite quadrilateral shape, and at least one of the surfaces of the friction pads or edge lengths of the kite quadrilaterals which are exclusively surrounded by embossed grooves become larger from radially inside to radially outside.

14. The drive train component according to claim 11, wherein each embossed groove is inclined in one of the two circumferential directions with respect to a radial course, and this results in its belonging to one of two groove groups.

15. The drive train component according to claim 14, wherein the inclination of the embossed grooves is given by means of an angle γ between a center line of the embossed groove and an inner circumference tangent at an interface between the course of the center line of the embossed groove and a course of the inner circumference of the friction pads.

16. The drive train component according to claim 15, wherein all intersection points of the center lines of two embossed grooves which have an intersection angle of 90 degrees lie on a circle with a radius Rₓ, which is between an inner radius (Rᵢ) and an outer radius (Rₐ) of a friction lining, where:
$${R}_{x} = \sqrt{{R}_{k}^{2} + {R}_{k}^{2}} with {R}_{k} = {R}_{l} sin α with α = 90 ° - γ$$

17. The drive train component according to claim 16, wherein all intersection points of the center lines of two embossed grooves which are not on the circle with a radius Rₓ have an intersection angle other than 90 degrees.

18. The drive train component according to claim 16, wherein two embossed grooves have the same value for the respective angle γ if the center lines of the two embossed grooves have their intersection point on the circle with radius Rₓ.

19. The drive train component according to claim 11, wherein all center lines of all embossed grooves form tangents to a common circle with a common radius Rₖ.

20. The drive train component according to claim 15, wherein the angle γ is chosen to be between 0 and 45°, preferably from the range between 40° and 44°.
